(19) United States
(12) Patent Application Publication
(10) Pub. No.: US 2026/0009687 A1
(43) Pub. Date: Jan. 8, 2026

(54) STRAIN GAUGE PRESSURE SENSOR AND MANUFACTURING METHOD THEREOF

(71) Applicant: GUANGDONG RUNYU SENSOR CO., LTD, Jiangmen, Guangdong (CN)

(72) Inventors: Shucheng LI, Jiangmen, Guangdong (CN); Haiquan LI, Jiangmen, Guangdong (CN); Yaohuan LIANG, Jiangmen, Guangdong (CN)

(21) Appl. No.: 19/134,686

(22) PCT Filed: Jun. 7, 2024
(86) PCT No.: PCT/CN2024/098241

§ 371 Date: May 30, 2025

(30) Foreign Application Priority Data
Oct. 11, 2023 (CN) 202311310216.3

(51) Int. Cl. G01L 19/04; G01L 1/18; G01L 1/22; G01L 9/00; G01L 9/06

(52) U.S. Cl. CPC G01L 19/04; G01L 1/18; G01L 1/2218; G01L 1/2293; G01L 9/0048; G01L 9/0052; G01L 9/06

(57) ABSTRACT

A strain gauge pressure sensor and a preparation method therefor, the strain gauge pressure sensor (100) comprising a base (10), a pressure seat (20), an elastic diaphragm (30), a prefabricated element (40), a strain gauge (50), and a circuit board (60). In the strain gauge pressure sensor and the preparation method therefor, connection between the elastic diaphragm (30) and the strain gauge (50) is achieved by using the pre-prepared prefabricated element (40), and the use of the pre-prepared prefabricated element (40) can effectively simplify a processing process. The processing difficulty is reduced, the occurrence of conditions such as bubbles and looseness caused by glass morphology being difficult to control is completely avoided, the overall processing precision and processing stability of the strain gauge pressure sensor are effectively guaranteed, and the overall quality of the strain gauge pressure sensor is ensured.

### CROSS-REFERENCE TO RELATED APPLICATIONS

The present application is a U.S. national stage entry under 37 U.S.C. § 371 of International application no. PCT/CN2024/098241, filed on Jun. 7, 2024, which claims priority to Chinese patent application No. 202311310216.3, filed on Oct. 11, 2023, the entire contents of which are incorporated herein by reference.

### TECHNICAL FIELD

This application relates to the technical field of pressure sensors, and particularly to a strain gauge pressure sensor and a method for manufacturing the same.

### BACKGROUND

Pressure sensors are mainly used to measure the pressure of force media and can provide accurate monitoring and control data for control systems. Strain gauge pressure sensors are based on pressure measurement, converting pressure signals into electrical output signals through amplification and adjustment of sensor signals.

At present, existing strain gauge pressure sensors are generally manufactured by sintering glass paste or glass powder. This manufacturing process is complex, involves a large number of process steps, and has low preparation efficiency. In addition, the morphology of glass is difficult to be controlled, and situations such as bubbles and looseness easily occur during the manufacturing process, it is difficult to control the quality of the sensor. As a result, the accuracy and stability of the sensor cannot be effectively guaranteed.

### SUMMARY

There are provided a strain gauge pressure sensor, and a method for manufacturing a strain gauge pressure sensor according to embodiments of the present disclosure. The technical solution is as below:

According to a first aspect of embodiments of the present application, there is provided a strain gauge pressure sensor, which includes:
a base with a through-going pressure channel;
a pressure seat with a through-going pressure guiding channel, wherein the pressure seat is provided on the base, and the pressure guiding channel communicates with the pressure channel;
an elastic diaphragm provided at an end of the pressure seat away from the base and corresponding to the pressure guiding channel, wherein the elastic diaphragm is deformable in response to a change of pressure;
a prefabricated element provided on a surface of the elastic diaphragm, wherein the prefabricated element is a prefabricated molded sheet;
a strain gauge provided on a surface of the prefabricated element away from the elastic diaphragm, wherein the strain gauge is configured to generate an electrical signal in response to deformation of the elastic diaphragm; and
a circuit board electrically connected to the strain gauge to receive and transmit the electrical signal from the strain gauge.

Optionally, the prefabricated element is a glass sheet, a glass fiber epoxy molded sheet, a gold-tin preform, or a silver-tin/antimony-tin molded sheet.

Optionally, each of the pressure seat, the prefabricated element, and the strain gauge has a coefficient of thermal expansion of 2 ppm/° C. to 20 ppm/° C.

Optionally, the strain gauge pressure sensor further includes a bracket fixed to the base and provided outside the pressure seat, the circuit board is fixed to the bracket.

Optionally, the strain gauge pressure sensor further includes a connection member fixed to an end of the base away from the pressure seat, the base is detachably connected to a to-be-measured pressure source via the connection member.

According to a second aspect of embodiments of the present application, there is provided a method for manufacturing a strain gauge pressure sensor, for manufacturing the strain gauge pressure sensor as mentioned above, which includes:
preparing the prefabricated element;
fixing the prefabricated element onto the pressure seat provided with the elastic diaphragm using a sacrificial solvent, to make the prefabricated element fixed to the surface of the elastic diaphragm;
fixing the strain gauge onto the surface of the prefabricated element away from the elastic diaphragm using the sacrificial solvent, to obtain an integrated structure of the pressure seat with the elastic diaphragm, the prefabricated element, and the strain gauge;
performing high-temperature treatment on the integrated structure to remove the sacrificial solvent and bonding the elastic diaphragm, the prefabricated element, and the strain gauge into a monolithic structure;
fixing the pressure seat with the monolithic structure to the base, to make the pressure guiding channel of the pressure seat communicate with the pressure channel of the base; and
connecting the circuit board to the pressure seat to establish an electrical connection of the circuit board with the strain gauge.

Optionally, the sacrificial solvent is terpineol.

Optionally, when performing the high-temperature treatment on the integrated structure, a protective inert gas is provided and a vacuum environment is maintained.

Optionally, the prefabricated element is prepared in advance by stamping or molding.

Optionally, the pressure seat is fixed to the base by welding, bonding, or interference fitting.

As apparent from the above technical solution, the present application has the following beneficial effects: in the strain gauge pressure sensor and its manufacturing method of the present application, the elastic diaphragm and the strain gauge are connected by a prepared prefabricated element, use of the prepared prefabricated element effectively simplifies the processing steps and reduces manufacturing complexity, thereby completely avoiding occurrence of issues such as bubbles or porosity caused by difficult control of glass morphology. As a result, it effectively ensures the overall machining accuracy and stability of the strain gauge pressure sensor, thereby guaranteeing the overall quality of the sensor.

### BRIEF DESCRIPTION OF THE DRAWINGS

FIG. 1 is a schematic structural diagram of an embodiment of the strain gauge pressure sensor of the present application.

FIG. 2 is an enlarged view at A in FIG. 1.

FIG. 3 is a schematic structural diagram of the prefabricated element in FIG. 2.

FIG. 4 is a schematic structural diagram during the process for manufacturing the strain gauge pressure sensor of the present application.

FIG. 5 is an enlarged view at B in FIG. 4.

FIG. 6 is a top view of FIG. 4.

FIG. 7 is an exploded view of FIG. 4.

FIG. 8 is a flowchart of a method for manufacturing the strain gauge pressure sensor of the present application.

Reference Numerals: 100—Strain gauge pressure sensor; 10—Base; 11—Pressure channel; 12—First opening; 13—Second opening; 14—Boss; 20—Pressure seat; 21—Pressure guiding channel; 22—First pressure opening; 23—Second pressure opening; 24—Recess; 30—Elastic diaphragm; 40—Prefabricated element; 50—Strain gauge; 60—Circuit board; 70—Connection member; 80—Bracket; 90—Aluminum bonding wire; 200—Sacrificial solvent

### DETAILED DESCRIPTION OF THE EMBODIMENTS

Typical embodiments demonstrating the features and advantages of the present application will be described in detail below. It should be understood that the present application can have various forms in different embodiments without departing from the scope of the present application, and the descriptions and drawings herein are essentially illustrative, not limiting the present application.

In the description of this present application, it should be noted that directional or positional references (such as up, down, left, right, front, and back) in the illustrated embodiments are for facilitating the description of the application and simplifying the description, rather than indicating or implying that the referred devices or components must have a specific orientation or be constructed and operated in a specific orientation. These descriptions are appropriate when the components are in the positions shown in the drawings. If the positional descriptions of these components change, the directional references shall be adjusted accordingly.

Additionally, the terms “first” and “second” are used for descriptive purposes only and should not be construed as indicating or implying relative importance or implicitly specifying the quantity of the indicated technical features. Thus, features defined with “first” and “second” may explicitly or implicitly include one or more such features. In the description of this application, “a plurality of” means two or more, unless explicitly and specifically defined otherwise.

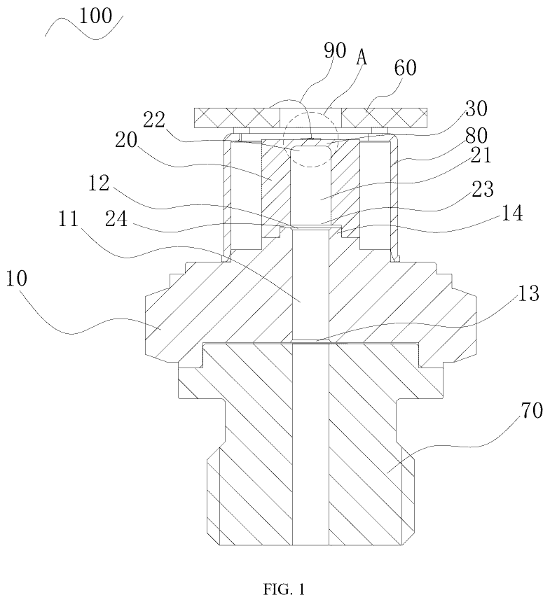

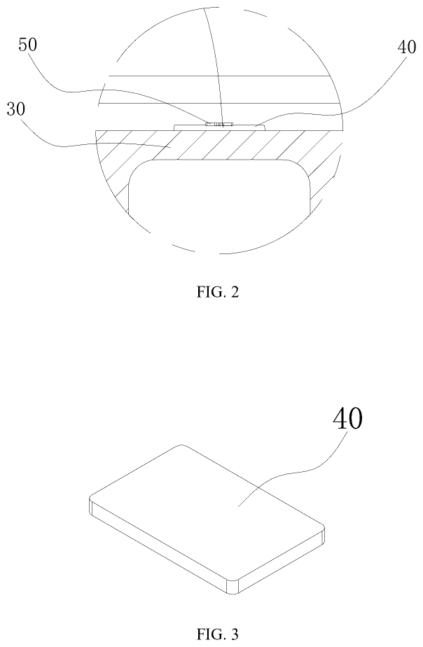

With reference to FIGS. 1 to 3, an embodiment of the present application provides a strain gauge pressure sensor 100, which includes a base 10, a pressure seat 20, an elastic diaphragm 30, a prefabricated element 40, a strain gauge 50, and a circuit board 60. In this strain gauge pressure sensor 100, the prefabricated element 40 efficiently and simply bonds the elastic diaphragm 30 and the strain gauge 50 into a monolithic structure. During use, the elastic diaphragm 30 deforms in response to change of pressure, and the strain gauge 50 outputs electrical signals related to pressure when the elastic diaphragm 30 generates strain, to achieve induction and measurement of pressure.

Specifically, the base 10 is provided with a through-going pressure channel 11. The pressure seat 20 is provided with a through-going pressure guiding channel 21, and is provided on the base 10, the pressure guiding channel 21 communicates with the pressure channel 11. The elastic diaphragm 30 is provided at an end of the pressure seat 20 away from the base 10, and corresponds to the pressure guiding channel 21, and can deform in response to change of pressure. The prefabricated element 40 is provided on the surface of the elastic diaphragm 30 and is a preformed molded sheet. The strain gauge 50 is provided on a surface of the prefabricated element 40 away from the elastic diaphragm 30, and can generate electrical signals with the deformation of the elastic diaphragm 30. The circuit board 60 is electrically connected to the strain gauge 50 to receive and transmit the electrical signals from the strain gauge 50.

In this embodiment, the base 10 serves as the main structural body of the entire strain gauge pressure sensor 100, functioning both as a connection foundation for the pressure seat 20 and a transitional structure for fixing the strain gauge pressure sensor 100 to a to-be-measured pressure source. The to-be-measured pressure source is typically a pressure pipeline in practical use.

The base 10 in this embodiment may be made of metal, ceramic, glass, etc., and can be integrally formed by a mold. The base 10 is provided with the through-going pressure channel 11, which forms a first opening 12 and a second opening 13 at both ends of the base 10.

In this embodiment, the strain gauge pressure sensor 100 further includes a connection member 70 provided at an end of the base 10 with the second opening 13. The connection member 70 and the base 10 may be detachably connected or integrally formed.

The connection member 70 is provided with a threaded interface adapted to be screwed with an interface of a pressure pipeline of the to-be-measured pressure source. The base 10 is hermetically docked with the pressure pipeline via the threaded interface of the connection member 70, so that the base 10 is detachably connected to the pressure pipeline of the pressure source. In addition to the threaded interface, the connection member 70 in this embodiment may also be hermetically docked with the pressure pipeline through other sealing structures, such as a snap interface or a snap fastener.

In this embodiment, the pressure seat 20 is provided at an end of the base 10 with the first opening 12, i.e., the pressure seat 20 is fixed to an end of the base 10 away from the connection member 70. The pressure seat 20 may be made of metal, ceramic, glass, etc.

The pressure seat 20 in this embodiment is provided with the through-going pressure guiding channel 21, which forms a first pressure opening 22 and a second pressure opening 23 at both ends of the pressure seat 20, respectively. An end of the pressure seat 20 with the second pressure opening 23 is fixed to the base 10.

In this embodiment, an end of the pressure seat 20 with the second pressure opening 23 is recessed to form a recess 24, and an end of the base 10 with the first opening 12 is protruded to form a boss 14. The boss 14 is adaptively and interference-fitted into the recess 24 to fix the pressure seat 20 to the base 10.

In other examples of this embodiment, the boss 14 may be protruded from the end of the pressure seat 20 with the second pressure opening 23, and the recess 24 may be recessed from an end of the base 10 with the first opening 12, which can also achieve the interference-fitted connection of the pressure seat 20 with the base 10.

Additionally, in other embodiments, the pressure seat 20 and the base 10 may be connected and fixed by welding, bonding, or other means, in addition to the above-mentioned interference-fitting method.

After the pressure seat 20 is fixed to the base 10, the first opening 12 of the base 10 is docked with the second pressure opening 23 of the pressure seat 20, and the pressure channel 11 of the base 10 communicates with the pressure guiding channel 21 of the pressure seat 20 via the first opening 12 and the second pressure opening 23.

In this embodiment, the elastic diaphragm 30 is provided at an end of the pressure seat 20 away from the base 10, and corresponds to the pressure guiding channel 21, and can deform in response to change of pressure.

The elastic diaphragm 30 in this embodiment may be made of metal and fixed to an end surface of the pressure seat 20 with the first pressure opening 22 by welding. The elastic diaphragm 30 covers the first pressure opening 22. When measuring the pressure of the pressure source, gas or liquid from the pressure source acts on the elastic diaphragm 30 through the pressure channel 11 and the pressure guiding channel 21, causing the elastic diaphragm 30 to deform in response to change of pressure.

Further, the strain gauge pressure sensor 100 in this embodiment further includes the prefabricated element 40 provided on a surface of the elastic diaphragm 30 away from the pressure seat 20. The prefabricated element 40 is a preformed mold sheet.

In this embodiment, the prefabricated element 40 is one of a glass sheet, a glass fiber epoxy molded sheet, a gold-tin preform, or a silver-tin/antimony-tin molded sheet. The prefabricated element 40 is prefabricated from corresponding materials through standardized processing and can be automatically bonded and packaged by machines, thereby simplifying the processing technology.

Compared with conventional pressure sensors manufactured by sintering glass paste or glass powder, the strain gauge pressure sensor 100 of this application effectively simplifies processing steps and reduces processing difficulty by using the prepared prefabricated element 40, completely avoiding problems such as bubbles and porosity caused by difficult control of glass morphology, effectively ensuring the overall processing accuracy and stability of the strain gauge pressure sensor 100, and ensuring the overall quality of the strain gauge pressure sensor 100.

The prefabricated element 40 in this embodiment generally has a rectangular outer contour, and there may be two prefabricated elements 40, which are both connected to the surface of the elastic diaphragm 30. In other examples of this embodiment, the prefabricated element 40 may also have other shapes such as circular, triangular, regular, or irregular, and the number of prefabricated elements 40 may also be three, one, six, etc., which are not excessively limited herein.

Further, the strain gauge pressure sensor 100 in this embodiment further includes the strain gauge 50, which may be a semiconductor strain gauge. The strain gauge 50 can convert stress into electrical signals under stress.

In this embodiment, the strain gauge 50 is provided on a surface of the prefabricated element 40 away from the elastic diaphragm 30. The strain gauge 50, the prefabricated element 40, and the pressure seat 20 have the same coefficient of thermal expansion to reduce the influence of stress between materials and ensure the accuracy of pressure data measurement.

Additionally, in other examples of this embodiment, the strain gauge 50, the prefabricated element 40, and the pressure seat 20 may have similar coefficients of thermal expansion, all within 2 ppm/° C. to 20 ppm/° C.

When measuring the pressure of the pressure source, gas or liquid from the pressure source acts on the elastic diaphragm 30 through the pressure channel 11 and the pressure guiding channel 21, the elastic diaphragm 30 deforms in response to change of pressure. The strain gauge 50 is connected to the elastic diaphragm 30 via the prefabricated element 40 and can generate strain corresponding to the deformation of the elastic diaphragm 30, to form a piezoresistive effect to convert pressure signals into electrical signals.

The strain gauge pressure sensor 100 in this embodiment further includes a circuit board 60, which is electrically connected to the strain gauge 50. The circuit board 60 and the strain gauge 50 may be electrically connected via an aluminum bonding wire 90, and the connection mode may include ultrasonic pressure welding or fusion welding, etc. The circuit board 60 is electrically connected to the strain gauge 50 to receive and transmit the electrical signals from the strain gauge 50.

In this embodiment, the strain gauge pressure sensor 100 further includes a bracket 80 fixed to the base 10 and provided outside the pressure seat 20. The circuit board 60 is fixed to the bracket 80. The bracket 80 provides a mounting position for the circuit board 60 on the pressure seat 20 and stable support for the circuit board 60.

The bracket 80 may be fixed to the base 10 by welding, bonding, or other means to ensure the stability of the connection of the bracket 80 with the base 10, thereby ensuring the firmness of the assembly of the circuit board 60.

The strain gauge pressure sensor 100 in this embodiment uses the prepared prefabricated element 40, such that it can effectively simplify processing steps, reduce processing difficulty, completely avoid problems such as bubbles and porosity caused by difficult control of glass morphology, thereby effectively ensuring the overall processing accuracy and stability of the strain gauge pressure sensor 100, and ensuring the overall quality of the strain gauge pressure sensor 100.

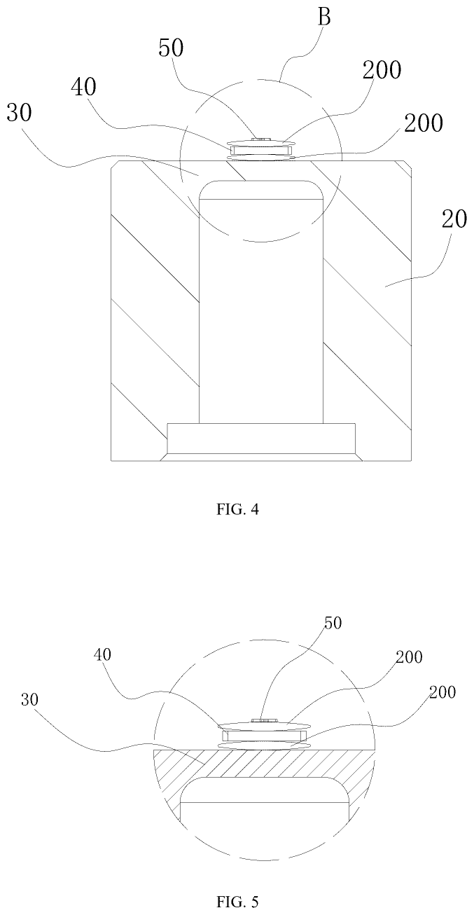

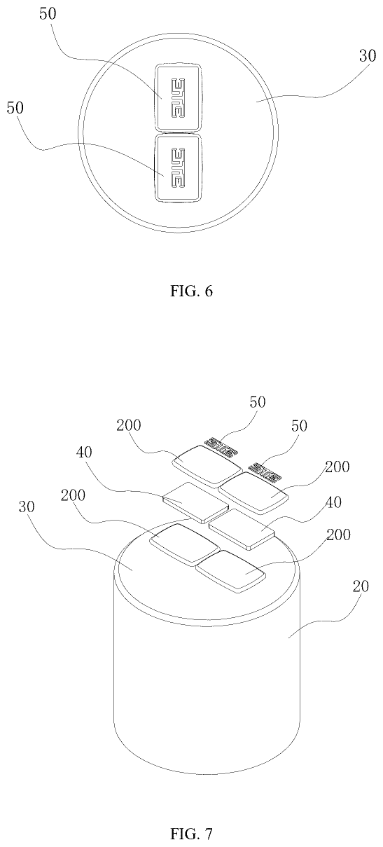

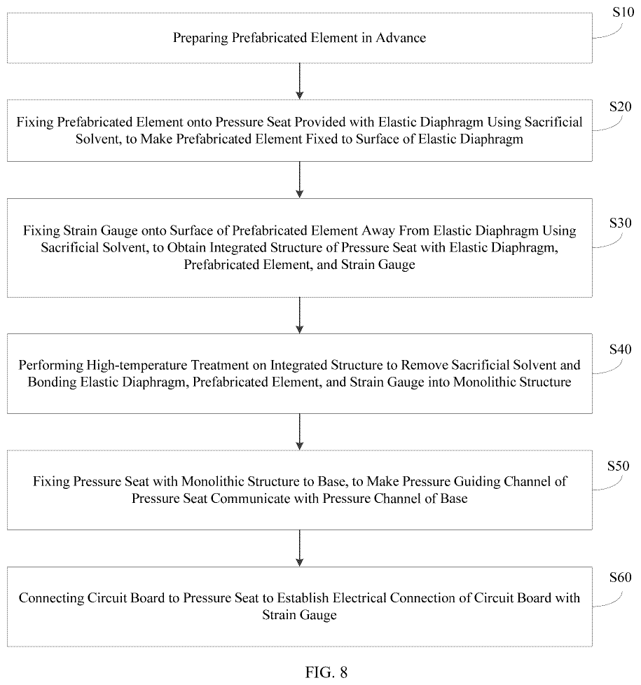

With reference to FIGS. 4 to 8, an embodiment of the present application further provides a method for manufacturing the strain gauge pressure sensor 100, including the following steps:
S10: preparing the prefabricated element 40 in advance;
S20: fixing the prefabricated element 40 on the pressure seat 20 provided with the elastic diaphragm 30 via a sacrificial solvent 200, to make the prefabricated element 40 fixed on the surface of the elastic diaphragm 30;
S30: fixing the strain gauge 50 on the surface of the prefabricated element 40 away from the elastic diaphragm 30 via the sacrificial solvent 200 to obtain an integral structure of the pressure seat 20 with the elastic diaphragm 30, the prefabricated element 40, and the strain gauge 50;
S40: performing high-temperature treatment on the integral structure to remove the sacrificial solvent 200 and bonding the elastic diaphragm 30, the prefabricated element 40, and the strain gauge 50 into a monolithic structure;
S50: fixing the pressure seat 20 with the monolithic structure to the base 10, such that the pressure guiding channel 21 of the pressure seat 20 communicates with the pressure channel 11 of the base 10;
S60: connecting the circuit board 60 to the pressure seat 20 to form an electrical connection of the circuit board 60 with the strain gauge 50.

In step S10, the prefabricated element 40 is one of a glass sheet, a glass fiber epoxy molded sheet, a gold-tin preform, or a silver-tin/antimony-tin molded sheet, and can be prepared by a stamping process or molding. This not only ensures the material composition but also the dimensional accuracy of the prefabricated element 40.

In steps S20 and S30, the sacrificial solvent 200 is terpineol. In addition to terpineol, other solvents with strong fixability and volatility at high temperatures may also be used.

Terpineol has a certain viscosity and can play a role in temporary fixation. Specifically, the sacrificial solvent 200 can effectively bond the prefabricated element 40 to the elastic diaphragm 30 of the pressure seat 20 and fix the strain gauge 50 to the prefabricated element 40, so that the elastic diaphragm 30, the prefabricated element 40, and the strain gauge 50 are temporarily fixed into an integral structure.

In step S40, the integral structure of the pressure seat 20 with the elastic diaphragm 30, the prefabricated element 40, and the strain gauge 50 is subjected to high-temperature treatment. The sacrificial solvent 200 volatilizes to be removed under high temperature. The prefabricated element 40 forms a high-temperature bond with the elastic diaphragm 30 and the strain gauge 50 under high temperature, so that the strain gauge 50 is fixed to the elastic diaphragm 30 via the prefabricated element 40.

In this embodiment, the prefabricated element 40, the strain gauge 50, and the pressure seat 20 have the same coefficient of thermal expansion to reduce the influence of material stress and ensure the connection stability between components. Additionally, in other examples of this embodiment, the strain gauge 50, the prefabricated element 40, and the pressure seat 20 may have similar coefficients of thermal expansion, all within 2 ppm/° C. to 20 ppm/° C.

Further, during the high-temperature bonding process, protective inert gas may be introduced into the bonding furnace chamber and an appropriate vacuum state may be maintained, thereby improving the bonding degree among the prefabricated element 40, the strain gauge 50, and the elastic diaphragm 30, reducing the influence of stress, and improving processing accuracy.

In other examples of this embodiment, the integral structure of the pressure seat 20 with the elastic diaphragm 30, the prefabricated element 40, and the strain gauge 50 may also be directly subjected to high-temperature treatment. In a non-vacuum state, the elastic diaphragm 30, the prefabricated element 40, and the strain gauge 50 can also form a bond under high temperature to connect into an integral monolithic structure.

After the bonding operation is completed, in step S50, the pressure seat 20 may be mounted on the base 10 by welding, bonding, interference fitting, or other means, and the pressure guiding channel 21 of the pressure seat 20 is communicated with the pressure channel 11 of the base 10 to achieve pressure transmission.

In step S60, the circuit board 60 may be mounted on the base 10 via the bracket 80. Specifically, the bracket 80 is fixed to the base 10 by welding, bonding, or other assembly means. The circuit board 60 is then connected to the bracket 80, and an electrical connection of the strain gauge 50 and the circuit board 60 is formed by ultrasonic pressure welding or fusion welding, thereby manufacturing the strain gauge pressure sensor 100.

When using the strain gauge pressure sensor 100 in this embodiment, it is first fixed to the to-be-measured pressure source via the connection member 70. Gas or liquid from the pressure source acts on the elastic diaphragm 30 through the pressure channel 11 and the pressure guiding channel 21, the elastic diaphragm 30 deforms in response to change of pressure. The strain gauge 50 is connected to the elastic diaphragm 30 via the prefabricated element 40 and can generate strain corresponding to the deformation of the elastic diaphragm 30, to form a piezoresistive effect to convert pressure signals into electrical signals, which are transmitted to the circuit board 60 to obtain the pressure value of the pressure source.

For the strain gauge pressure sensor and the manufacturing method there of in this embodiment, the elastic diaphragm is connected to the strain gauge by using the prepared prefabricated element, the use of the prepared prefabricated element can effectively simplify processing steps, reduce processing difficulty, completely avoid problems such as bubbles and porosity caused by difficult control of glass morphology, thereby effectively ensuring the overall processing accuracy and stability of the strain gauge pressure sensor, and ensuring the overall quality of the strain gauge pressure sensor.

Although the present application has been described with reference to several exemplary embodiments, it should be understood that the terminology used herein is for the purpose of description and exemplification rather than limitation. Since the present application can be embodied in various forms without departing from the spirit or essential characteristics thereof, it is to be understood that the above-described embodiments are not limited to any of the details of the foregoing description, but rather should be construed broadly within the spirit and scope defined by the appended claims. All changes and modifications that fall within the scope of the claims or their equivalents are therefore intended to be embraced by the appended claims.

1. A strain gauge pressure sensor, comprising:
a base with a through-going pressure channel;
a pressure seat with a through-going pressure guiding channel, wherein the pressure seat is provided on the base, and the pressure guiding channel communicates with the pressure channel;
an elastic diaphragm provided at an end of the pressure seat away from the base and corresponding to the pressure guiding channel, wherein the elastic diaphragm is deformable in response to a change of pressure;
a prefabricated element provided on a surface of the elastic diaphragm, wherein the prefabricated element is a prefabricated molded sheet;
a strain gauge provided on a surface of the prefabricated element away from the elastic diaphragm, wherein the strain gauge is configured to generate an electrical signal in response to deformation of the elastic diaphragm wherein the strain gauge is connected to the elastic diphergan through the prefabricated element and the strain gauge, the prefabricated element, and the elastic diaphragm are bonded together to form an integral structure: the strain gauge the prefabricated sheet, and the pressure seat have a same coefficient of thermal expansion; and
a circuit board electrically connected to the strain gauge to receive and transmit the electrical signal from the strain gauge.

2. The strain gauge pressure sensor according to claim 1, wherein the prefabricated element is a glass sheet, a glass fiber epoxy molded sheet, a gold-tin preform, or a silver-tin/antimony-tin molded sheet.

3. The strain gauge pressure sensor according to claim 1, wherein each of the pressure seat, the prefabricated element, and the strain gauge has a coefficient of thermal expansion of 2 ppm/° C. to 20 ppm/° C.

4. The strain gauge pressure sensor according to claim 1, further comprising a bracket fixed to the base and provided outside the pressure seat, wherein the circuit board is fixed to the bracket.

5. The strain gauge pressure sensor according to claim 1, further comprising a connection member fixed to an end of the base away from the pressure seat, wherein the base is detachably connected to a to-be-measured pressure source via the connection member.

6. A method for manufacturing a strain gauge pressure sensor, for manufacturing the strain gauge pressure sensor according to claim 1, comprising:
preparing the prefabricated element;
fixing the prefabricated element onto the pressure seat provided with the elastic diaphragm using a sacrificial solvent, to make the prefabricated element fixed to the surface of the elastic diaphragm;
fixing the strain gauge onto the surface of the prefabricated element away from the elastic diaphragm using the sacrificial solvent, to obtain an integrated structure of the pressure seat with the elastic diaphragm, the prefabricated element, and the strain gauge;
performing high-temperature treatment on the integrated structure to remove the sacrificial solvent and bonding the elastic diaphragm, the prefabricated element, and the strain gauge into a monolithic structure;
fixing the pressure seat with the monolithic structure to the base, to make the pressure guiding channel of the pressure seat communicate with the pressure channel of the base; and
connecting the circuit board to the pressure seat to establish an electrical connection of the circuit board with the strain gauge.

7. The method according to claim 6, wherein the sacrificial solvent is terpineol.

8. The method according to claim 6, wherein when performing the high-temperature treatment on the integrated structure, a protective inert gas is provided and a vacuum environment is maintained.

9. The method according to claim 6, wherein the prefabricated element is prepared in advance by stamping or molding.

10. The method according to claim 6, wherein the pressure seat is fixed to the base by welding, bonding, or interference fitting.

11. The strain gauge pressure sensor according to claim 5, wherein the through-going pressure channel forms a first opening and a second opening at two ends of the base.

12. The strain gauge pressure sensor according to claim 11, wherein the connection member is provided at an end of the base with the second opening, and the connection member and the base are detachably connected or integrally formed.

13. The strain gauge pressure sensor according to claim 11, wherein the connection member is provided with a threaded interface adapted to be screwed with an interface of a pressure pipeline of a to-be-measured pressure source, and the base is hermetically docked with the pressure pipeline via the threaded interface of the connection member, so that the base is detachably connected to the pressure pipeline of the pressure source.

14. The strain gauge pressure sensor according to claim 11, wherein the pressure seat is provided at an end of the base with the first opening.

15. The strain gauge pressure sensor according to claim 11, wherein the through-going pressure guiding channel forms a first pressure opening and a second pressure opening at two ends of the pressure seat, respectively, and an end of the pressure seat with the second pressure opening is fixed to the base.

16. The strain gauge pressure sensor according to claim 15, wherein an end of the pressure seat with the second pressure opening is recessed to form a recess, and an end of the base with the first opening is protruded to form a boss, and the boss is adaptively and interference-fitted into the recess to fix the pressure seat to the base.

17. The strain gauge pressure sensor according to claim 16, wherein the boss is protruded from the end of the pressure seat with the second pressure opening, and the recess is recessed from an end of the base with the first opening.
